(19) United States
(12) Patent Application Publication
(10) Pub. No.: US 2017/0041263 A1
(43) Pub. Date: Feb. 9, 2017

(54) LOCATION-BASED ON-DEMAND ANONYMOUS CHATROOM

(71) Applicant: Oded Yehuda Shekel, Sunnyvale, CA (US)

(72) Inventor: Oded Yehuda Shekel, Sunnyvale, CA (US)

(21) Appl. No.: 14/821,617

(22) Filed: Aug. 7, 2015

(51) Int. Cl. H04L 12/58; H04L 29/08

(52) U.S. Cl. CPC H04L 51/12; H04L 51/04; H04L 67/18

(57) ABSTRACT

A method and a device are disclosed including software components that allow users to join an ongoing local anonymous chat room, create a new one, or vote to support the creation of a new one. The chat room system prevents a potential participant from joining a local chat room if the participant does not reside in a predefined geographic area as other users/participants of the chat room. The chat room system may further restrict the types of interactions allowed in the anonymous chat room, such as abusive language. Such restrictions may be done automatically via software, a human administrator, majority and/or weighted vote of other participants, or a combination of these. In some embodiments, chat rooms may be further restricted to a particular subject or industry, an age range, gender, or list of locations, among others. Physical or geographic proximity may be verified via IP address geo-location techniques.

### TECHNICAL FIELD

This application relates generally to online communications. More specifically, this application relates to location-based, on-demand, anonymous chat rooms with oversight and restrictions.

### BRIEF DESCRIPTION OF THE DRAWINGS

The drawings, when considered in connection with the following description, are presented for the purpose of facilitating an understanding of the subject matter sought to be protected.

FIG. 1 shows an embodiment of a network computing environment wherein the disclosure may be practiced;

FIG. 2 shows an embodiment of a computing device that may be used in the network computing environment of FIG. 1;

FIG. 3A shows an example chat room environment usable with the computing device of FIG. 2;

FIG. 3B shows example chat rooms owned by various parties based on an anonymous chat room services system;

FIG. 4A shows an example chat room software application interface with user comments;

FIG. 4B shows an example chat room software application interface with abusive language blocked by chat room administrator;

FIG. 5 shows an example chat room software application interface for creating a new chat room;

FIG. 6 shows an example chat room software application interface for registering an initiator/creator of the new chat room of FIG. 5; and

FIG. 7 shows an example chat room software application interface usable by an owner/operator of the chat room

### DETAILED DESCRIPTION

While the present disclosure is described with reference to several illustrative embodiments described herein, it should be clear that the present disclosure should not be limited to such embodiments. Therefore, the description of the embodiments provided herein is illustrative of the present disclosure and should not limit the scope of the disclosure as claimed. In addition, while following description references particular office software suites like Microsoft Office® it will be appreciated that the disclosure may be used with other types of document processing suites, such as Open Office®, Corel® and the like.

Briefly described, a system and a method are disclosed including software components that allow users to join an ongoing local anonymous chat room, create a new one, or vote to support the creation of a new one. The chat room system prevents a potential participant from joining a local chat room if the participant does not reside in a predefined geographic area as other users/participants of the chat room. The chat room system may further restrict the types of interactions allowed in the anonymous chat room, such as abusive language. Such restrictions may be done automatically via software, a human administrator, majority and/or weighted vote of other participants, or a combination of these. In some embodiments, chat rooms may be further restricted to a particular subject or industry, an age range, gender, or list of locations, among others. Physical or geographic proximity may be verified via physical address and/or phone number of a new participant during registration, via IP address geolocation techniques, or a combination of above, among others.

Cloud computing refers to software applications and data that are accessed remotely via the web and are maintained and managed by third-party actors in contrast to applications residing and accessed locally on a user's computer. Some cloud computing solutions enable users to share and work together on documents and objects while others let users store content and files on a location that is accessible from any computer. The facilities in the cloud are typically operated by third-party actors who rent out resources, such as data storage, services, computing capacity, server capacity, applications, and the like to users who are not concerned with the operation and maintenance of these resources. For example, storage facilities may be upgraded, protected from intruders and hackers, backed up, archived, and made available to users in a transparent manner, such that the user need not be concerned with such matters.

With the ubiquity of users' internet access there is an ever increasing demand for expanded services, functionality, online storage, sharing capabilities, and the like. Chat rooms are virtual meeting places in the cloud that allow users to interact (send and receive text, pictures, hotlinks, and other informational and multimedia content) on various subjects, ask or answer questions, or just to socialize. Chat rooms are accessible via the Internet from anywhere in the world. A user may connect with other users in the chat room by having the URL (Uniform Resource Locator) of the chat room. The chat room itself is a computer interface, such as an application window or web browser, via which the user may read and write comments, view pictures or video, and possibly speak and listen to voice communications. But, the global access to chat rooms also reduces the usefulness of the chat room in some respects because users on the other side of the world or residing in a different country and culture do not have as much in common with local users. As such, interests diverge and chance of in-person meetings or collaboration diminishes. Among other benefits further described below, location-based anonymous chat room may enable certain business models such as targeted advertisements by location, chat room sponsorship by location owners, businesses hosting rooms for employees, and the like.

### Illustrative Operating Environment

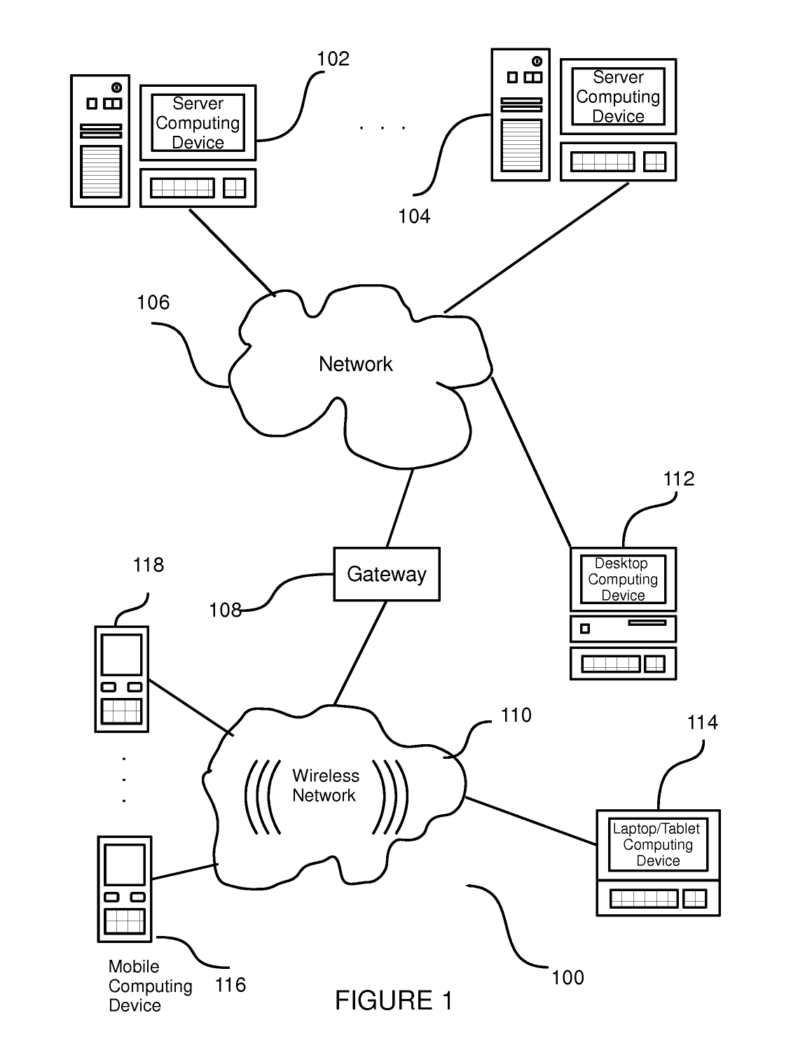

FIG. 1 shows components of an illustrative environment in which the disclosure may be practiced. Not all the shown components may be required to practice the disclosure, and variations in the arrangement and type of the components may be made without departing from the spirit or scope of the disclosure. System 100 may include Local Area Networks (LAN) and Wide Area Networks (WAN) shown collectively as Network 106, wireless network 110, gateway 108 configured to connect remote and/or different types of networks together, client computing devices 112-118, and server computing devices 102-104.

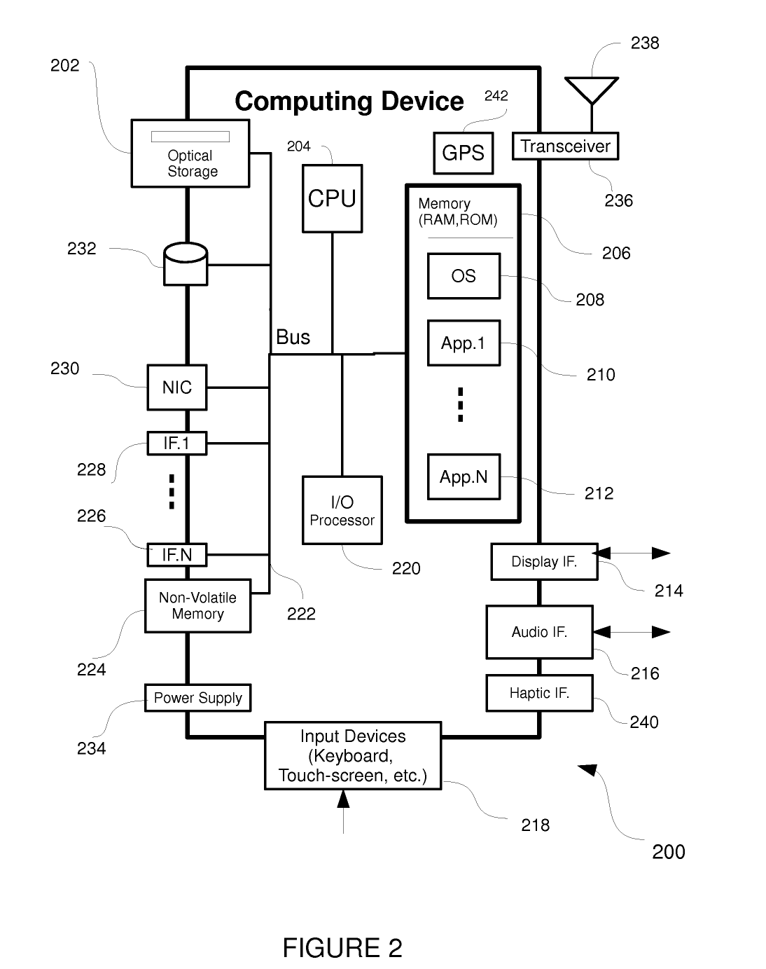

One embodiment of a computing device usable as one of client computing devices 112-118 is described in more detail below with respect to FIG. 2. Briefly, however, client computing devices 112-118 may include virtually any device capable of receiving and sending a message over a network, such as wireless network 110, or the like. Such devices include portable devices such as, cellular telephones, smart phones, display pagers, radio frequency (RF) devices, music players, digital cameras, infrared (IR) devices, Personal Digital Assistants (PDAs), handheld computers, laptop computers, wearable computers, tablet computers, integrated devices combining one or more of the preceding devices, or the like. Client device 112 may include virtually any computing device that typically connects using a wired communications medium such as personal computers, multiprocessor systems, microprocessor-based or programmable consumer electronics, network PCs, or the like. In one embodiment, one or more of client devices 112-118 may also be configured to operate over a wired and/or a wireless network.

Client devices 112-118 typically range widely in terms of capabilities and features. For example, a cell phone may have a numeric keypad and a few lines of monochrome LCD display on which only text may be displayed. In another example, a web-enabled client device may have a touch sensitive screen, a stylus, and several lines of color LCD display in which both text and graphic may be displayed.

A web-enabled client device may include a browser application that is configured to receive and to send web pages, web-based messages, or the like. The browser application may be configured to receive and display graphic, text, multimedia, or the like, employing virtually any web based language, including a wireless application protocol messages (WAP), or the like. In one embodiment, the browser application may be enabled to employ one or more of Handheld Device Markup Language (HDML), Wireless Markup Language (WML), WMLScript, JavaScript, Standard Generalized Markup Language (SMGL), HyperText Markup Language (HTML), eXtensible Markup Language (XML), or the like, to display and send information.

Client computing devices 12-118 also may include at least one other client application that is configured to receive content from another computing device, including, without limit, server computing devices 102-104. The client application may include a capability to provide and receive textual content, multimedia information, or the like. The client application may further provide information that identifies itself, including a type, capability, name, or the like. In one embodiment, client devices 112-118 may uniquely identify themselves through any of a variety of mechanisms, including a phone number, Mobile Identification Number (MIN), an electronic serial number (ESN), mobile device identifier, network address, such as IP (Internet Protocol) address, Media Access Control (MAC) layer identifier, or other identifier. The identifier may be provided in a message, or the like, sent to another computing device.

Client computing devices 112-118 may also be configured to communicate a message, such as through email, Short Message Service (SMS), Multimedia Message Service (MMS), instant messaging (IM), internet relay chat (IRC), Mardam-Bey's IRC (mIRC), Jabber, or the like, to another computing device. However, the present disclosure is not limited to these message protocols, and virtually any other message protocol may be employed.

Client devices 112-118 may further be configured to include a client application that enables the user to log into a user account that may be managed by another computing device. Such user account, for example, may be configured to enable the user to receive emails, send/receive IM messages, SMS messages, access selected web pages, download scripts, applications, or a variety of other content, or perform a variety of other actions over a network. However, managing of messages or otherwise accessing and/or downloading content, may also be performed without logging into the user account. Thus, a user of client devices 112-118 may employ any of a variety of client applications to access content, read web pages, receive/send messages, or the like. In one embodiment, for example, the user may employ a browser or other client application to access a web page hosted by a Web server implemented as server computing device 102. In one embodiment, messages received by client computing devices 112-118 may be saved in non-volatile memory, such as flash and/or PCM, across communication sessions and/or between power cycles of client computing devices 112-118.

Wireless network 110 may be configured to couple client devices 114-118 to network 106. Wireless network 110 may include any of a variety of wireless sub-networks that may further overlay stand-alone ad-hoc networks, and the like, to provide an infrastructure-oriented connection for client devices 114-118. Such sub-networks may include mesh networks, Wireless LAN (WLAN) networks, cellular networks, and the like. Wireless network 110 may further include an autonomous system of terminals, gateways, routers, and the like connected by wireless radio links, and the like. These connectors may be configured to move freely and randomly and organize themselves arbitrarily, such that the topology of wireless network 110 may change rapidly.

Wireless network 110 may further employ a plurality of access technologies including 2nd (2G), 3rd (3G) generation radio access for cellular systems, WLAN, Wireless Router (WR) mesh, and the like. Access technologies such as 2G, 3G, and future access networks may enable wide area coverage for mobile devices, such as client devices 114-118 with various degrees of mobility. For example, wireless network 110 may enable a radio connection through a radio network access such as Global System for Mobil communication (GSM), General Packet Radio Services (GPRS), Enhanced Data GSM Environment (EDGE), WEDGE, Bluetooth, High Speed Downlink Packet Access (HSDPA), Universal Mobile Telecommunications System (UMTS), Wi-Fi, Zigbee, Wideband Code Division Multiple Access (WCDMA), and the like. In essence, wireless network 110 may include virtually any wireless communication mechanism by which information may travel between client devices 102-104 and another computing device, network, and the like.

Network 106 is configured to couple one or more servers depicted in FIG. 1 as server computing devices 102-104 and their respective components with other computing devices, such as client device 112, and through wireless network 110 to client devices 114-118. Network 106 is enabled to employ any form of computer readable media for communicating information from one electronic device to another. Also, network 106 may include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another.

In various embodiments, the arrangement of system 100 includes components that may be used in and constitute various networked architectures. Such architectures may include peer-to-peer, client-server, two-tier, three-tier, or other multi-tier (n-tier) architectures, MVC (Model-View-Controller), and MVP (Model-View-Presenter) architectures among others. Each of these are briefly described below.

Peer to peer architecture entails use of protocols, such as P2PP (Peer To Peer Protocol), for collaborative, often symmetrical, and independent communication and data transfer between peer client computers without the use of a central server or related protocols.

Client-server architectures includes one or more servers and a number of clients which connect and communicate with the servers via certain predetermined protocols. For example, a client computer connecting to a web server via a browser and related protocols, such as HTTP, may be an example of a client-server architecture. The client-server architecture may also be viewed as a 2-tier architecture.

Two-tier, three-tier, and generally, n-tier architectures are those which separate and isolate distinct functions from each other by the use of well-defined hardware and/or software boundaries. An example of the two-tier architecture is the client-server architecture as already mentioned. In a 2-tier architecture, the presentation layer (or tier), which provides user interface, is separated from the data layer (or tier), which provides data contents. Business logic, which processes the data may be distributed between the two tiers.

A three-tier architecture, goes one step farther than the 2-tier architecture, in that it also provides a logic tier between the presentation tier and data tier to handle application data processing and logic. Business applications often fall in and are implemented in this layer.

MVC (Model-View-Controller) is a conceptually many-to-many architecture where the model, the view, and the controller entities may communicate directly with each other. This is in contrast with the 3-tier architecture in which only adjacent layers may communicate directly.

MVP (Model-View-Presenter) is a modification of the MVC model, in which the presenter entity is analogous to the middle layer of the 3-tier architecture and includes the applications and logic.

Communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. Network 106 may include any communication method by which information may travel between computing devices. Additionally, communication media typically may enable transmission of computer-readable instructions, data structures, program modules, or other types of content, virtually without limit. By way of example, communication media includes wired media such as twisted pair, coaxial cable, fiber optics, wave guides, and other wired media and wireless media such as acoustic, RF, infrared, and other wireless media.

### Illustrative Computing Device Configuration

FIG. 2 shows an illustrative computing device 200 that may represent any one of the server and/or client computing devices shown in FIG. 1. A computing device represented by computing device 200 may include less or more than all the components shown in FIG. 2 depending on the functionality needed. For example, a mobile computing device may include the transceiver 236 and antenna 238, while a server computing device 102 of FIG. 1 may not include these components. Those skilled in the art will appreciate that the scope of integration of components of computing device 200 may be different from what is shown. As such, some of the components of computing device 200 shown in FIG. 2 may be integrated together as one unit. For example, NIC 230 and transceiver 236 may be implemented as an integrated unit. Additionally, different functions of a single component may be separated and implemented across several components instead. For example, different functions of I/O processor 220 may be separated into two or more processing units.

With continued reference to FIG. 2, computing device 200 includes optical storage 202, Central Processing Unit (CPU) 204, memory module 206, display interface 214, audio interface 216, input devices 218, Input/Output (I/O) processor 220, bus 222, non-volatile memory 224, various other interfaces 226-228, Network Interface Card (NIC) 320, hard disk 232, power supply 234, transceiver 236, antenna 238, haptic interface 240, and Global Positioning System (GPS) unit 242. Memory module 206 may include software such as Operating System (OS) 208, and a variety of software application programs and/or software modules/components 210-212. Such software modules and components may be stand-alone application software or be components, such as DLL (Dynamic Link Library) of a bigger application software. Computing device 200 may also include other components not shown in FIG. 2. For example, computing device 200 may further include an illuminator (for example, a light), graphic interface, and portable storage media such as USB drives. Computing device 200 may also include other processing units, such as a math co-processor, graphics processor/accelerator, and a Digital Signal Processor (DSP).

Optical storage device 202 may include optical drives for using optical media, such as CD (Compact Disc), DVD (Digital Video Disc), and the like. Optical storage devices 202 may provide inexpensive ways for storing information for archival and/or distribution purposes.

Central Processing Unit (CPU) 204 may be the main processor for software program execution in computing device 200. CPU 204 may represent one or more processing units that obtain software instructions from memory module 206 and execute such instructions to carry out computations and/or transfer data between various sources and destinations of data, such as hard disk 232, I/O processor 220, display interface 214, input devices 218, non-volatile memory 224, and the like.

Memory module 206 may include RAM (Random Access Memory), ROM (Read Only Memory), and other storage means, mapped to one addressable memory space. Memory module 206 illustrates one of many types of computer storage media for storage of information such as computer readable instructions, data structures, program modules or other data. Memory module 206 may store a basic input/output system (BIOS) for controlling low-level operation of computing device 200. Memory module 206 may also store OS 208 for controlling the general operation of computing device 200. It will be appreciated that OS 208 may include a general-purpose operating system such as a version of UNIX, or LINUX™, or a specialized client-side and/or mobile communication operating system such as Windows Mobile™, Android®, or the Symbian® operating system. OS 208 may, in turn, include or interface with a Java virtual machine (JVM) module that enables control of hardware components and/or operating system operations via Java application programs.

Memory module 206 may further include one or more distinct areas (by address space and/or other means), which can be utilized by computing device 200 to store, among other things, applications and/or other data. For example, one area of memory module 206 may be set aside and employed to store information that describes various capabilities of computing device 200, a device identifier, and the like. Such identification information may then be provided to another device based on any of a variety of events, including being sent as part of a header during a communication, sent upon request, or the like. One common software application is a browser program that is generally used to send/receive information to/from a web server. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message. However, any of a variety of other web based languages may also be employed. In one embodiment, using the browser application, a user may view an article or other content on a web page with one or more highlighted portions as target objects.

Display interface 214 may be coupled with a display unit (not shown), such as liquid crystal display (LCD), gas plasma, light emitting diode (LED), or any other type of display unit that may be used with computing device 200. Display units coupled with display interface 214 may also include a touch sensitive screen arranged to receive input from an object such as a stylus or a digit from a human hand. Display interface 214 may further include interface for other visual status indicators, such Light Emitting Diodes (LED), light arrays, and the like. Display interface 214 may include both hardware and software components. For example, display interface 214 may include a graphic accelerator for rendering graphic-intensive outputs on the display unit. In one embodiment, display interface 214 may include software and/or firmware components that work in conjunction with CPU 204 to render graphic output on the display unit.

Audio interface 216 is arranged to produce and receive audio signals such as the sound of a human voice. For example, audio interface 216 may be coupled to a speaker and microphone (not shown) to enable communication with a human operator, such as spoken commands, and/or generate an audio acknowledgement for some action.

Input devices 218 may include a variety of device types arranged to receive input from a user, such as a keyboard, a keypad, a mouse, a touchpad, a touch-screen (described with respect to display interface 214), a multi-touch screen, a microphone for spoken command input (describe with respect to audio interface 216), and the like.

I/O processor 220 is generally employed to handle transactions and communications with peripheral devices such as mass storage, network, input devices, display, and the like, which couple computing device 200 with the external world. In small, low power computing devices, such as some mobile devices, functions of the I/O processor 220 may be integrated with CPU 204 to reduce hardware cost and complexity. In one embodiment, I/O processor 220 may the primary software interface with all other device and/or hardware interfaces, such as optical storage 202, hard disk 232, interfaces 226-228, display interface 214, audio interface 216, and input devices 218.

An electrical bus 222 internal to computing device 200 may be used to couple various other hardware components, such as CPU 204, memory module 206, I/O processor 220, and the like, to each other for transferring data, instructions, status, and other similar information.

Non-volatile memory 224 may include memory built into computing device 200, or portable storage medium, such as USB drives that may include PCM arrays, flash memory including NOR and NAND flash, pluggable hard drive, and the like. In one embodiment, portable storage medium may behave similarly to a disk drive. In another embodiment, portable storage medium may present an interface different than a disk drive, for example, a read-only interface used for loading/supplying data and/or software.

Various other interfaces 226-228 may include other electrical and/or optical interfaces for connecting to various hardware peripheral devices and networks, such as IEEE 1394 also known as FireWire, Universal Serial Bus (USB), Small Computer Serial Interface (SCSI), parallel printer interface, Universal Synchronous Asynchronous Receiver Transmitter (USART), Video Graphics Array (VGA), Super VGA (SVGA), and the like.

Network Interface Card (NIC) 230 may include circuitry for coupling computing device 200 to one or more networks, and is generally constructed for use with one or more communication protocols and technologies including, but not limited to, Global System for Mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, Bluetooth, Wi-Fi, Zigbee, UMTS, HSDPA, WCDMA, WEDGE, or any of a variety of other wired and/or wireless communication protocols.

Hard disk 232 is generally used as a mass storage device for computing device 200. In one embodiment, hard disk 232 may be a Ferro-magnetic stack of one or more disks forming a disk drive embedded in or coupled to computing device 200. In another embodiment, hard drive 232 may be implemented as a solid-state device configured to behave as a disk drive, such as a flash-based hard drive. In yet another embodiment, hard drive 232 may be a remote storage accessible over network interface 230 or another interface 226, but acting as a local hard drive. Those skilled in the art will appreciate that other technologies and configurations may be used to present a hard drive interface and functionality to computing device 200 without departing from the spirit of the present disclosure.

Power supply 234 provides power to computing device 200. A rechargeable or non-rechargeable battery may be used to provide power. The power may also be provided by an external power source, such as an AC adapter or a powered docking cradle that supplements and/or recharges a battery.

Transceiver 236 generally represents transmitter/receiver circuits for wired and/or wireless transmission and receipt of electronic data. Transceiver 236 may be a stand-alone module or be integrated with other modules, such as NIC 230. Transceiver 236 may be coupled with one or more antennas for wireless transmission of information.

Antenna 238 is generally used for wireless transmission of information, for example, in conjunction with transceiver 236, NIC 230, and/or GPS 242. Antenna 238 may represent one or more different antennas that may be coupled with different devices and tuned to different carrier frequencies configured to communicate using corresponding protocols and/or networks. Antenna 238 may be of various types, such as omni-directional, dipole, slot, helical, and the like.

Haptic interface 240 is configured to provide tactile feedback to a user of computing device 200. For example, the haptic interface may be employed to vibrate computing device 200, or an input device coupled to computing device 200, such as a game controller, in a particular way when an event occurs, such as hitting an object with a car in a video game.

Global Positioning System (GPS) unit 242 can determine the physical coordinates of computing device 200 on the surface of the Earth, which typically outputs a location as latitude and longitude values. GPS unit 242 can also employ other geo-positioning mechanisms, including, but not limited to, triangulation, assisted GPS (AGPS), E-OTD, CI, SAI, ETA, BSS or the like, to further determine the physical location of computing device 200 on the surface of the Earth. It is understood that under different conditions, GPS unit 242 can determine a physical location within millimeters for computing device 200. In other cases, the determined physical location may be less precise, such as within a meter or significantly greater distances. In one embodiment, however, a mobile device represented by computing device 200 may, through other components, provide other information that may be employed to determine a physical location of the device, including for example, a MAC address.

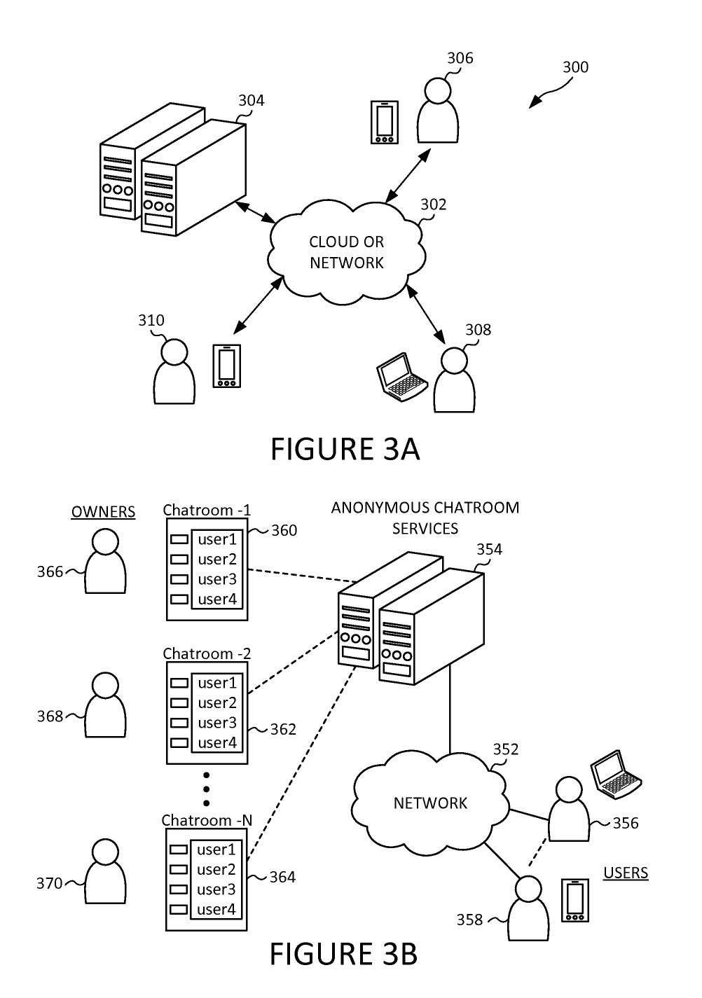

FIG. 3 shows an example chat room environment usable with the computing device of FIG. 2. In various embodiments, chat room communication environment 300 includes a computer network or computing cloud 302, chat room servers 304, and users 306, 308, and 310 communicating through the facilities provided by the chat room servers 304.

In various embodiments, computing or communication devices used by the users 306-310 may include any of the computing devices discussed with respect to FIGS. 1 and 2.

In various embodiments, a chat room system may include a server component, a client component, and other various utility components that perform various tasks such as location verification. In various embodiments, chat room system may be implemented by a hardware and/or software system using one or more software components executing on the illustrative computing device of FIG. 2, on both the server and client sides. One or more functions of a server device or a client device may be performed by each respective software module recorded on a medium such as an optical disk, magnetic disk or tape, volatile or non-volatile computer memory, and the like, or transmitted by various communication techniques using various network and/or communication protocols, as described above with respect to FIG. 1. For example, one or more separate software modules may be used for each of the functions in the system, including server and/or client devices, such as creating a user interface of the chat room, providing a client-side software application for user interactions with the chat room, initiating and terminating chat room sessions, login and logout functions, user authentication and authorization, password management, filtering input text for abusive language, location verification, new user registration, vote management for creating a new chat room, communication module to coordinate and order conversations between chat room participants by transmitting and receiving conversation data, and other functions needed to operate a chat room.

Typically, on the client side, local user interactions, such as user interface management and update, data input, data rendering, and the like may be functions that are implemented by software modules residing and running on the client device. Other chat room-wide functions that are common to all participants and the operation of the chat room, such as authentication and authorization, location verification, coordination of conversations between multiple parties, user voting for new chat room creation, and the like may be implemented on the server side. Those skilled in the art will appreciate that one function may implemented using multiple software modules or several functions may be implemented using one software module. With further reference to FIG. 2, these software modules are generally loaded into the memory module 206 of the computing device for execution.

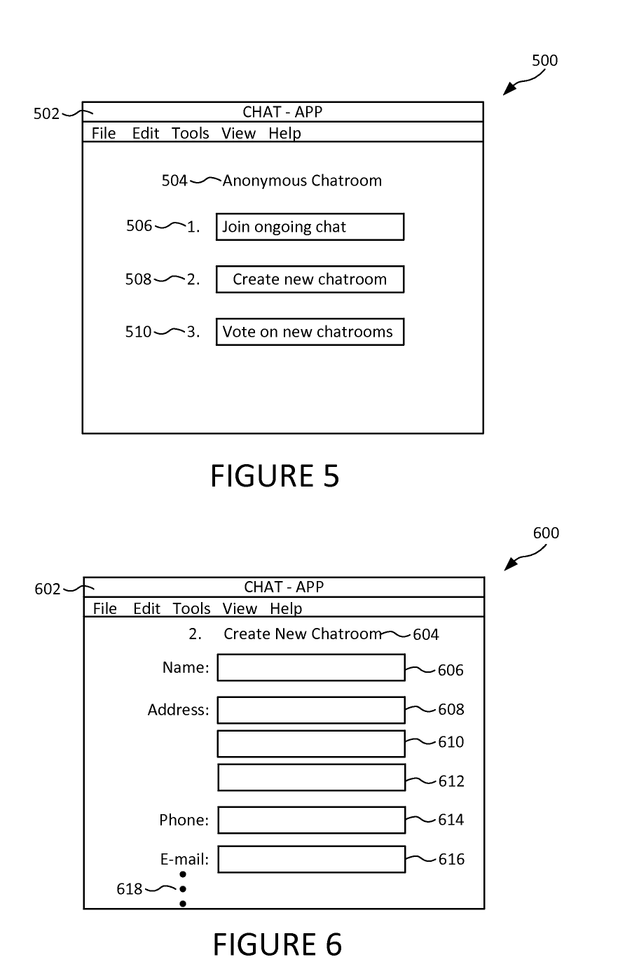

In various embodiments, a user who wishes to create a new local anonymous chat room, runs a chat software application, like a stand-alone application or a web page in a browser, on his client device and selects the appropriate options from the user interface, as further described below with respect to FIGS. 5 and 6.

In various embodiments, as a person travels around city or move from place to place inside or outside a city or state, the chat room system may alert them that they are approaching a particular chat room in that location and encourage them to join. For example, if a person is approaching a restaurant with a chat room, when he is within one mile of the restaurant, he may receive a notification, either from an anonymous chat room services system or from the particular chat room associated with the restaurant that he is approaching the location for the chat room and is welcome to join an anonymous conversation. This interaction is further described below with respect to FIG. 3B.

FIG. 3B shows example chat rooms owned by various parties based on an anonymous chat room services system. In various embodiments, chat room system 350 includes servers 354 to support particular chat rooms 360, 362, and 364 created by various owners/operators 366, 368, and 370 and coupled with computer network 352. Various users 356 and 358 may use these chat room via the network.

In various embodiments, anonymous chat room services allow various potential chat room owners to create a new chat room, as further described below with respect to FIGS. 5 and 6. Each new chat room may include a separate identity and access path or address that makes it uniquely identifiable and usable for comments and interactions by various public users. Users 356 and 358 may connect to a particular chat room directly or via anonymous chat room servers 354. Regardless of the connection path from users 356 and 358 to chat rooms 360-364, that is, whether directly or through servers, the chat rooms 360-364 are ultimately created and controlled by the anonymous chat room services. In one embodiment, the software for the implementation of the chat room may be downloaded to a private server of an owner 366 to serve users 356-358 directly through the network 352. In this embodiment, the chat room software resides and runs on the owner's computer, but the overall permissions to operate and the ultimate control (such as upgrading the chat room, shutting it down, collecting data and reports from it, or otherwise controlling it) lies with the anonymous chat room services' owner. In this embodiments, the users connect directly to the particular chat room's servers.

In another embodiment, the owner 366 may create a new chat room and an associated account, which he operates and controls, but the chat room actually resides and runs on the anonymous chat room servers operated by the owner/operator of the anonymous chat room services. In this embodiments, the users connect to the particular chat room via the master anonymous chat room servers 354.

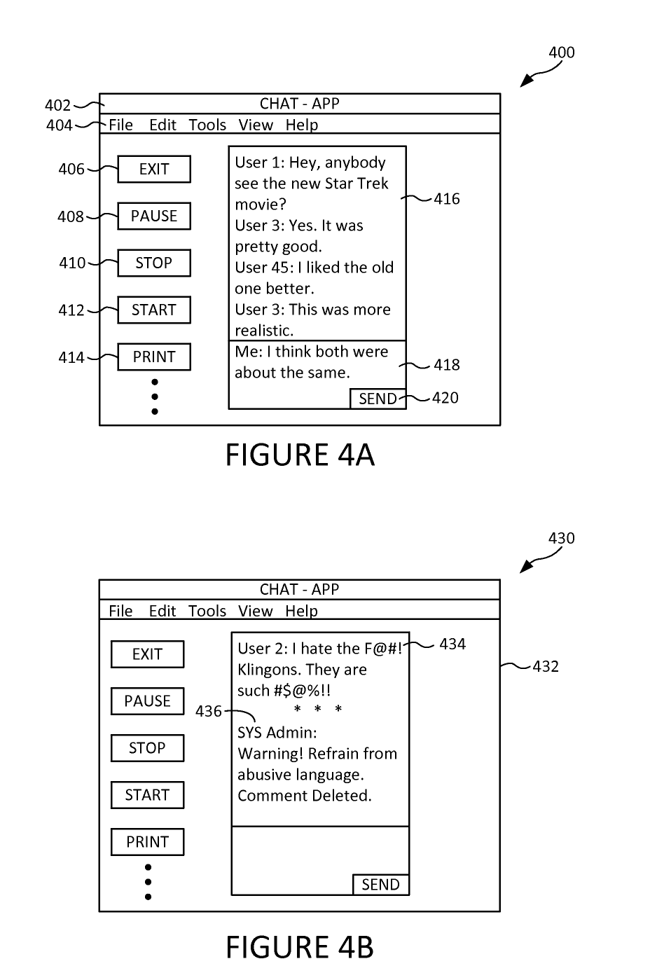

FIG. 4A shows an example chat room software application interface with user comments. In various embodiments, a client-side chat room user interface 400 includes a chat room application window 402 having various menu options 404, Exit button 406, Pause button 408, Stop button 410, Start button 412, Print button 414, and other buttons as needed. It further includes a conversation window pane 416, an input window pane 418, and a send button 420.

In various embodiments, a user may launch and run the chat room application 402, select an existing chat room and interact with other anonymous users through the conversation window pane 416 using input window pane 418. In various embodiments, the chat room application may be an internet browser like Firefox™ and Internet Explorer™, a standalone application, a plug-in component plugged into a web browser or another application such as an office suite document application, or other forms of software components. In various embodiments, the chat room system executing on the server side of the system may assign a non-authentic (with respect to user's true identity) unique ID to each participant, different from the participant's real name or other identifiable information associated with the participant, in the chat room to maintain privacy and anonymity. In some embodiments, the user may be given a choice of available IDs to use. As each user inputs his comments into the input pane and sends it to the chat room system, the system filters it for abusive language and sends it to the other clients in the chat room to appear in their conversation windows. This way all users see substantially the same conversation in the chat room at the same time with minor transmission delays.

In various embodiments, the client-side users have access to various control buttons, control menu items, short-cut keys, or other graphical components usable to control the behavior and/or functions of the chat room application. For example, the user may choose to pause or stop his chat session using buttons 408 and 410. Pressing the Pause button causes temporary interruption of conversation until Start button 412 is pressed to resume the conversation. During pause no one can send or receive comments to/from the user who paused his chat application. Afterwards, the user can continue where he left off and get all the conversation data he missed during the pause. Stop button 410 may stop the session and after starting it, the parts of conversation the user missed during stop will not be available to the user who stopped his session, but he can continue conversation from the time he presses Start button 412. The Print button 414 can print part or all of the conversation. And the Exit button 406 may terminate the current chat session and the user will have to login again if he wants to enter this or another chat room.

FIG. 4B shows an example chat room software application interface with abusive language blocked by chat room administrator. In various embodiments, chat room software application interface 430 includes the chat room application window 432 and abusive dialog or conversation 434. An interference or control comment 436 by administrator may take control away from the user with abusive language.

In various embodiments, to create a safe and civil environment, the chat system may filter out selected predefined words, phrases, terms, and the like, which may be considered by most participants in the chat room to be offensive. The offensive terms may include crude language, threatening words, discriminatory terms, derogatory terms, and the like. In some embodiments, the chat room system may include a base number of predefined words to be filtered, while in other embodiments, the chat room system may add to or modify the list of the predefined words based on user/participant feedback, suggestion, or vote.

In some embodiments, the abusive terms in a conversation may be actively monitored and filtered automatically by filter software, while in other embodiments the conversation may be filtered by a person such as an administrator or supervisor. In other embodiments, both a live person assisted by software filter and other tools may monitor the conversation. In various embodiments, the filtering may be passive and only take action if a participant complains about a particular term or participant, in contrast to active monitoring and filtering of a conversation. An abusive participant who does not respond to repeated warnings may be banned from a particular chat room. In some embodiments, posting of comments to the chat room may be delayed by a random amount of time to allow time for real-time filtering and avoid immediate posting of inappropriate language on the chat room. The delay will also help maintain anonymity and privacy by breaking the chronological association between the time a user types in or otherwise enters comments (for example, by voice commands) and the time his comments appear in the chat room.

In various embodiments, other users of the chat room may be able to mark or label a comment as offensive. Such data may be captured by the chat room operator or service and be used to block a user from using the system. What constitutes an offensive comment may be determined by a majority vote of all the users of the chat room or by other methods. A list of offensive terms may be constructed and updated as new offensive terms are added or removed. A user may be blocked if he exceeds a predefined threshold of offensive or offending comments as defined by the system. For example, a limit of five offensive comments per month may be defined and advertised by the chat room system and whoever that exceeds that limit may be banned from using the chat room for a predefined period of time, such as one week or one month and then be allowed back in. Multiple thresholds may be defined with varying degrees of reprimand including permanent ban from the chat room.

FIG. 5 shows an example chat room software application interface for creating a new chat room. In various embodiments, chat room interface 500 includes chat room application window 502, title identification 504, and user choices such as option 506 for joining an ongoing chat room, option 508 for creating new chat room, and option 510 for voting on creating a new chat room.

In various embodiments, joining an ongoing or existing chat room entails selecting option 506 and picking a particular chat room to participate in. In some embodiments, the chat rooms may be identified by name or number entered by the user, while in other embodiments, a list of available chat rooms may be presented by the chat room server to the user to select from.

In various embodiments, an initiating user may want to create a new local anonymous chat room by selecting option 508. The user may be subsequently presented with a dialog window by the chat room server, via the chat room client user interface running on his local client device, to enter the name, description, purpose, and other characteristics of the new chat room. The chat room server may then initiate a participant voting process by asking existing chat room participants whether they want to participate in the new chat room and/or whether they approve the creation of the new chat room. During this process, the chat room server directs the voting query towards participant within a predetermined physical distance from the initiating user and other participants. Alternatively, the voting query may be directed to participants within a predefined geographical neighborhood, such as a city, a county, a state, or neighborhood or region within a larger city or region. The voting results or decision regarding allowance or creation of the new chat room may be based on majority votes, weighted votes (where some votes count more than others, for example, based on seniority in the chat room, position/responsibilities, past record or other similar criteria), or other voting techniques like tiered votes where different classes of votes are defined and treated differently.

In various embodiments, the chat room may be subject to secondary restrictions, in addition to the location or physical proximity of chat room participants, based on criteria including a particular subject or industry, an age range, gender, or list of locations, among others.

In some embodiments, the initiating user may be in a first locality but request the creation of a new chat room in a different locality for participants in the different locality only. This way, the new chat room is still a local and anonymous chat room, but is created by a non-local entity. This arrangement may be useful in cases where a central organization or administrator want to create local chat rooms in various regions. For example, a political organization or an industrial group may be interested in getting its members or followers to interact and candidly and anonymously make their opinions known about various decisions or courses of action by the initiating political or industrial group.

FIG. 6 shows an example chat room software application interface for registering an initiator/creator of the new chat room of FIG. 5. In various embodiments, chat room interface 600 includes chat room window 602, action title 604, name field 606, address fields 608, 610, and 612, phone field 614, and email address field 616, and other fields 618.

In various embodiments, the interface 600 is used to acquire and/or verify the locality and other information of an initiating user who wants to create a new anonymous local chat room. Those skilled in the art will appreciate that many fields may be included in this user interface to collect various information that are not shown in this figure, such as sex, age, occupation, marital status, and the like.

In various embodiments, the location of the initiating user may be verified by geolocation techniques such as mapping the IP address of the user to the locality assigned to that IP address. IP address data may primarily be found in the Regional Internet Registries (RIR) which allocate and distribute IP addresses to users located within their service regions. Examples of RIRs include American Registry for Internet Numbers (ARIN), RIPE Network Coordination Centre (RIPE NCC), Asia-Pacific Network Information Centre (APNIC), among others. Other sources of geolocation data include data mining or geographic location information submitted by users. For example, a weather web site might ask visitors for a city name to find their local forecast. This way, the city name and, thus, location is associated with the IP address of the visitor, which may be data mined later. Another example is to pair a user's IP address with the address information in his/her account profile. Those skilled in the art will appreciate that many other public and private sources of IP location data may be available to ascertain the geographic location of an IP associated with a user.

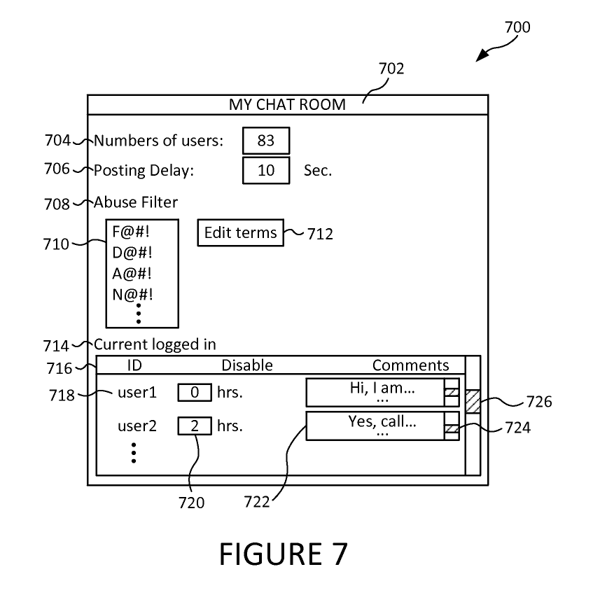

FIG. 7 shows an example chat room software application interface usable by an owner/operator of the chat room. In various embodiments, chat room owner's software user interface 700 includes chat room window 702, information fields such as number current users of the chat room 704, posting delay time 706, abusive language filter 708, abusive terms list 710, abusive terms list edit button 712, currently active or logged in users 714, user list 716 having a scroll block 726, user list entries 718, user ban status 720, and user comments 722 having a scroller 724.

In various embodiments, user interface 700 is utilized by the owner or creator of the particular chat room to exercise some control over the chat room, particularly for day-to-day operations and management of users. Some of the control aspects such as creation and destruction of the chat room, basic policies such as anonymity, and security of the chat room may be implemented at the servers of the anonymous chat room services, in a more central fashion along with the control of other chat rooms associated with other owners/creators.

In various embodiments, a number of components on the user interface may be set via the by the owner to control operational characteristics, such as posting delay and abuses filter, while other components may be utilized more for information and statistics gathering. For example, the owner may set the posting delay 706 to 10 seconds to delay the posting of any comment by 10 seconds to allow the abusive language filtering system search and find any disallowed terms. Those skilled in the art will appreciate that automatic software stream filters may be utilized for this purpose that compare each word in the single or multiple streams of words (from one or multiple users, or from multiple users integrated at some point into one stream) flowing into the chat room from the users to each of the disallowed words in the abusive terms and take an appropriate action, such as holding or deleting the offending portion of the stream, issuing a warning to the user who sent the abusive terms, notifying the administrator, and the like.

In various embodiments, the abusive terms list 710 may be edited (add/delete/change) to alter the restricted words, terms, phrases, symbols, and the like. The user may enter the edit mode (similar to the operation of a basic word processor) by activating the Edit Terms button 712.

In various embodiments, a list of currently logged in users 716 may be displayed to the owner, who may scroll up and down the list using the scroll bar 726. Selecting a particular user, such as user 2, may present additional information about that user, such as history, duration of login, any penalties for using restricted terms, a disabled account for some period such as two hours or two days, and the like. The comment field for each anonymous user 722 may also include a scroll bar to view more of the comments by that user. The identification of each user is only done by generic techniques such as “User 1,” so that the real identity of the user is never known to the chat room owner.

It will be understood that each step of the processes described above, and combinations of steps, may be implemented by computer program instructions. These program instructions may be provided to a processor to produce a machine, such that the instructions, which execute on the processor, enable implementing the actions specified. The computer program instructions may be executed by a processor to cause a series of operational steps to be performed by the processor to produce a computer implemented process such that the instructions, which execute on the processor to provide steps for implementing the actions. The computer program instructions may also cause at least some of the operational steps to be performed in parallel. Moreover, some of the steps may also be performed across more than one processor, such as might arise in a multi-processor computer system. In addition, one or more steps or combinations of steps described may also be performed concurrently with other steps or combinations of steps, or even in a different sequence than described without departing from the scope or spirit of the disclosure.

Accordingly, steps of processes or methods described support combinations of techniques for performing the specified actions, combinations of steps for performing the specified actions and program instruction for performing the specified actions. It will also be understood that each step, and combinations of steps described, can be implemented by special purpose hardware based systems which perform the specified actions or steps, or combinations of special purpose hardware and computer instructions.

It will be further understood that unless explicitly stated or specified, the steps described in a process are not ordered and may not necessarily be performed or occur in the order described or depicted. For example, a step A in a process described prior to a step B in the same process, may actually be performed after step B. In other words, a collection of steps in a process for achieving an end-result may occur in any order unless otherwise stated.

Changes can be made to the claimed invention in light of the above Detailed Description. While the above description details certain embodiments of the invention and describes the best mode contemplated, no matter how detailed the above appears in text, the claimed invention can be practiced in many ways. Details of the system may vary considerably in its implementation details, while still being encompassed by the claimed invention disclosed herein.

Particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the claimed invention to the specific embodiments disclosed in the specification, unless the above Detailed Description section explicitly defines such terms. Accordingly, the actual scope of the claimed invention encompasses not only the disclosed embodiments, but also all equivalent ways of practicing or implementing the claimed invention.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

The above specification, examples, and data provide a complete description of the manufacture and use of the claimed invention. Since many embodiments of the claimed invention can be made without departing from the spirit and scope of the disclosure, the invention resides in the claims hereinafter appended. It is further understood that this disclosure is not limited to the disclosed embodiments, but is intended to cover various arrangements included within the spirit and scope of the broadest interpretation so as to encompass all such modifications and equivalent arrangements.

What is claimed is:

1. A communication system comprising:
a server computing device configured to send and receive chat room information contents via a computer network to and from client computing devices, respectively, wherein the chat room contents originate from client computing devices that are within a predefined distance from each other; and
a client computing device coupled with the server computing device and configured to present the information contents to a user associated with the client computing device and receive information input by the user to send to the server computing device.

2. The communication system of claim 1, wherein the chat room information contents appear in an anonymous chat room.

3. The communication system of claim 2, wherein the anonymous chat room was previously formed on demand from a participant.

4. The communication system of claim 1, wherein the server computing device is further configured to accept a request for creation of a new anonymous chat room.

5. The communication system of claim 4, wherein the new anonymous chat room is limited to participants from a predefined geographic area.

6. The communication system of claim 4, wherein the server computing device is further configured to take votes from existing chat rooms' participants to create the new anonymous chat room.

7. The communication system of claim 1, wherein the server computing device is further configured to restrict language abuse in chat room information contents.

8. The communication system of claim 1, wherein the client computing device is further configured to present the information contents using a web browser.

9. The communication system of claim 1, wherein the server computing device is further configured to restrict language abuse in chat room information contents based on reports of abusive language received from other users.

10. A computer-implemented chat room system comprising:
a chat room server coupled with a computer network and configured to create a new local anonymous chat room limited to participation by client devices within a predefined geographic area; and
a plurality of client devices within the predefined geographic area and coupled with the chat room server via the computer network.

11. The system of claim 10, wherein the chat room server is further configured to take votes from existing chat rooms' participants to create the new local anonymous chat room.

12. The system of claim 11, wherein the votes taken are used for decision-making based on majority voting.

13. The system of claim 10, wherein the chat room server is further configured to restrict participation in the new local anonymous chat room based on secondary criteria including at least one of a particular subject or industry, an age range, and gender.

14. The system of claim 10, wherein the chat room server is further configured to restrict language abuse in the new local anonymous chat room.

15. The system of claim 14, wherein the language abuse is restricted using delayed posting of comments.

16. A method of communication, the method comprising:
anonymously receiving information, via a chat room system, from an anonymous sender; and
anonymously posting information to the chat room system, wherein the chat room system services are limited to anonymous participants within a predefined distance from other participants of the chat room.

17. The method of claim 16, further comprising restricting abusive language in the chat room system.

18. The method of claim 16, wherein anonymously receiving information comprises receiving the information via a computer network from participants identified by non-authentic identifiers.

19. The method of claim 16, further comprising receiving a request from an existing chat room participant to create a new anonymous chat room for a particular locality.

20. The method of claim 19, wherein the particular locality is different from a locality of the existing chat room participant.

21. The method of claim 16, wherein anonymously posting information comprises posting the information with a random delay.

22. The method of claim 16, further comprising notifying a user of being in close proximity to a particular anonymous chat room.
